(19) United States
(12) Patent Application Publication
(10) Pub. No.: US 2024/0038203 A1
(43) Pub. Date: Feb. 1, 2024

(54) IRON NICKEL GUITAR STRINGS AND METHODS OF MAKING THEREOF

(71) Applicant: Blue Magic Music LLC, Lutz, FL (US)

(72) Inventors: Dean Farley, Onset, MA (US); Robert L. Butterworth, Lutz, FL (US)

(21) Appl. No.: 18/222,162

(22) Filed: Jul. 14, 2023

Related U.S. Application Data
(60) Provisional application No. 63/390,670, filed on Jul. 20, 2022.

(51) Int. Cl. G10D 3/22; G10D 3/10; G10H 3/18; G10D 1/08

(52) U.S. Cl. CPC G10D 3/22; G10D 3/10; G10H 3/182; G10D 1/085; G10H 2220/505

(57) ABSTRACT

Guitar strings composed of an Iron and Nickel smelted alloy for use with wide aperture single coil pickups, and guitars therefor.

### RELATED APPLICATION

This application claims the benefit of U.S. Provisional Patent Application Ser. No. 63/390,670 entitled IRON NICKEL GUITAR STRINGS AND METHODS OF MAKING THEREOF, filed Jul. 20, 2022, the teachings of which are incorporated herein by reference.

### FIELD

This disclosure relates generally to the manufacturing and use of strings for stringed instruments. More specifically, this disclosure relates to guitar strings made of composite metal alloys for use with guitar pickups to produce music having superior tonal quality with minimal noise from the pickups.

### BACKGROUND

There are several types of guitar pickups for use with electric guitars. The three main categories of guitar pickups are single coil pickups, P90 pickups and humbucker pickups. All pickups are designed to detect the sound made by a guitar string, convert the sound to an electrical signal, and send the converted electrical signal to an amplifier so that the music at sufficient volume can be played by a speaker. Guitar pickups have over the years been developed to affect the manner in which the tonal quality of the music is produced. Since all guitar pickups utilize magnetic coils to convert the vibrations of the strings to an electrical signal, the structures of the pickups can produce deleterious electrical noise effects, sometimes called “humming” which ultimately degrades the amplified sound being played over the speaker.

Guitar pickups are made of a main core material, for example a ferrite, which is a ceramic material made by mixing iron oxide with other metal elements and alnico, which is a family of iron alloys consisting of aluminum nickel and cobalt. The cores are then wrapped in coils of copper wire and held in place by a bobbin which usually is made of molded plastic. The only two variables in pickup construction which can be adjusted to improve the tone and reduce noise is the number of coils wrapping the core, and the materials that form the core in the ceramic. Thus, pickup design is limited regarding what can be changed to improve the quality of sound produced by the guitar using the pickups. Pickups have been used at least since the 1940s, and a well-known pickup was designed and patented by Seth E. Lover in 1959 who was issued US Pat. No. 2,896,491, Magnetic Pickup For Stringed Musical Instrument, the teachings of which are specifically incorporated herein by reference.

Over the years much effort has been engaged in by those with skill in the art to improve pickups. The single coil pickup of the Lover patent produces a very bright sound and has the huge disadvantage of producing a loud humming due to the noise inherent in the production of sound with a single coil pickup. A design emerged to combat noise called the “P90” pickup, which was produced by the Gibson® guitar company primarily for use with its EBO bass guitar, although the P90 has evolved to be used with many other types of guitars also The P90 pickup produces less humming than a standard single coil pickup, but also produces more depth of sound than a single coil pickup, thereby improving the tonal quality of the music produced by a guitar using a P90 pickup. P90 pickups also are of a single coil design but they have a wider bobbin which means that the electrical signal produced by the P90 pickup are a higher output than that of the single coil pickup, which accounts for the richer depth of sound produced by a guitar with a P90 pickup. However, the P90 pickups, while reducing noise humming, do not eliminate it and so the P90 pickups also suffer from undesirable noise production. Moreover, the original Gibson® manufactured P-90 guitar pickup (which is classified as a “wide aperture single-coil pickup”) presents inherent balance problems for the guitarist. If the musician uses the standard pure nickel strings that were standard issue at the time the P-90 were developed (1940s, onwards), there is a huge sonic imbalance between the plain (unwound) treble strings and the lower three bass strings (wound with an outer wrap around a plain steel core). The transition playing between the higher three plain treble strings to the lower bass strings will result in the treble strings being much too shrill and out of balance when shifting to wound bass strings. The guitarist will experience the bass strings sounding far too muddy, creating a situation where tone controls on either the guitar (and/or the guitar amplifier), will not remedy this tonal anomaly sound across all six strings. Hence, the P90 pickups do not produce a smooth or even transition from string to string. The struggle for balance and focus across all the strings in a guitar plagues guitarists as they strive for pure sound and good tone in their playing. A description of P90 pickups and variations thereof are taught in U.S. Pat. No. 8,664,5078, Lawing, entitled Musical Instrument Pickup And Methods, the teachings of which are specifically incorporated herein by reference.

The humbucker pickup was another improvement in electric guitar pickup design. Humbucker pickups have two magnets, instead of just one like P90 and single coil pickups. They usually either look like two single coils joined together or, a large pickup encased in a metal covering. The dual magnet design reduces humming found at high gain, which has been colloquially referred to as “hum bucking”, hence the name “humbucker”. Humbucker pickups produce a warmer sound with more mellow tone than single magnet pickups and are also louder as they have a higher output. Humbucker pickups are described, for example, in U.S. Pat. No. 5,136,918, Riboloff, the teachings of which are specifically incorporated herein by reference.

Other approaches to improve tonal quality and noise/humming reduction involve improving the design of the guitar strings themselves. As mentioned above, the original electric guitar strings fabricated of nickel, which produced a rich and warm sound. However, pure nickel is expensive and so alternatives have been developed. For example, steel core strings wrapped in copper were developed in the mid- 1970s. See, e.g., U.S. Pat. No. 4,055,038, Conklin, Jr., the teachings of which are specifically incorporated herein by reference. Today, most guitar strings have a steel core, coated or wrapped in a nickel finish. See, e.g., US Published Patent Application 20140041506A, Jones, teachings of which are specifically incorporated herein by reference. Steel-nickel alloys have also been proposed. See, e.g., U.S. Pat. No. 6,120,910, Szenics, the teachings of which are specifically incorporated by reference. The nickel finish helps to maintain the richness of the sound from the string, while the steel core reduces costs. The

American Society for Testing and Materials International (ASTMI) has developed a specification directed to steel wire for manufacturing guitar strings, and this specification is published by ASTMI as A228/A228M—14, the teachings of which are specifically incorporated herein by reference. Methods of manufacturing wire guitar strings are described generally in U.S. Pat. No. 6,256,872, Landtroop et al; the teachings of which are specifically incorporated herein by reference.

Other, more exotic steel guitar strings have been proposed. For example, maraging steel strings have been proposed, see U.S. Pat. No. 8,642,861m Ball et al., the teachings of which are specifically incorporated herein by reference. Ball et al. also proposes adding 6%-14% nickel to the maraging steel composition. However, maraging steel is an expensive form of steel to make and has an unusually high tensile strength. It is also very hard. Thus, maraging steel strings can damage guitar frets and necks, and is not preferred for use with most guitars. Even more exotic is the iron-nickel guitar string described in U.S. Pat. No. 8,049,088, Richter, the teachings of which are specifically incorporated herein by reference. Amorphous steel and steel alloys, sometimes called metallic glass or glassy metal, are non-crystalline, while metals themselves exhibit a crystal structure. Amorphous steel and amorphous steel alloys are quite brittle, and they have not yet found widespread commercial uses due in part to their exotic material properties, but have potential uses that are being investigated.

### SUMMARY

The present disclosure solves the aforementioned problems extant in the art by providing a guitar string comprising a unique metal alloy of iron and nickel. Preferably, the alloy is between about 90% iron and 10% nickel. More preferably the alloy is between about 95% iron and 5% nickel. Even more preferably the alloy is between about 98% iron and 2% nickel. The guitar strings of the present disclosure will effectively reduce noise and humming in use with any of the presently known guitar pickups, for example, single coil pickups, single coil wide aperture pickups or humbucker pickups.

The disclosure will be best understood by a skilled artisan by reading the following description in conjunction with the drawings which are first described briefly below.

### BRIEF DESCRIPTION OF THE DRAWINGS

FIG. 1 is a plan view of an electric guitar using a pickup and strings of the present disclosure.

FIG. 2A shows an electric guitar body having a single coil pickup and using strings of the present disclosure.

FIG. 2B shows an electric guitar body having a wide aperture single coil pickup and using strings of the present disclosure.

FIG. 2C shows an electric guitar body having a humbucker pickup and using strings of the present disclosure.

FIG. 3A is an isometric plan view of a single coil pickup

FIG. 3B is an isometric plan view of a single coil wide aperture pickup.

FIG. 3C is an isometric plan view of a humbucker pickup.

FIG. 4 is an exploded schematic view of a single coil pickup.

FIG. 5 is an exploded schematic view of a single coil wide aperture pickup.

FIG. 6 is an exploded schematic view of a humbucker pickup.

FIG. 7A is an isometric view of a roll of nickel cast iron sheet.

FIG. 7B is view of an isometric view of a roll of nickel cast iron wire as an intermediate product of a manufacturing process for fabricating guitar strings of the present disclosure.

FIG. 8A is an isometric view of a bundle of cut nickel cast iron wires of various lengths as a further intermediate product of a manufacturing process for fabricating guitar strings of the present disclosure.

FIG. 8B is an isometric view of finished guitar strings of the present disclosure.

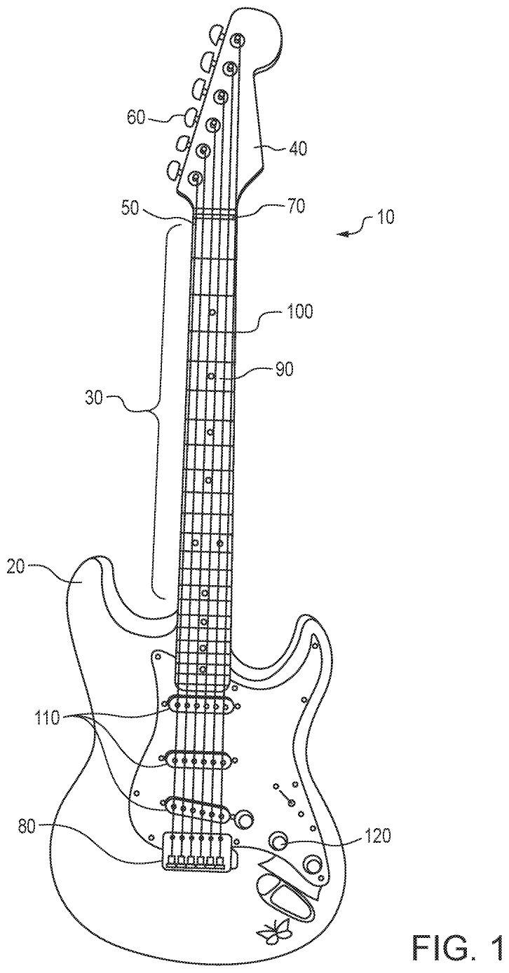

### DETAILED DESCRIPTION

Referring now to the drawings where like reference numerals refer to like elements, Figure shows an electric guitar 10. While the strings of the present invention are particularly useful for use with electric guitars, these strings will also find use with any instrument having strings to produce music. Acoustic guitars, stringed orchestra instruments (violins, cellos, violas, string basses, harps), banjos, ukuleles, pianos and all such manner of instruments which use, at least in part, a string to produce music will find the use of the strings of the present disclosure advantageous in making music. For convenience, and since the present strings are particularly useful for producing high quality tone, low noise music for electric guitars, throughout the rest of this disclosure, the subject matter will be described with reference to electric guitars, which may simple be referred to as a guitar or guitars.

Guitar 10 includes a body 20 connected to the proximal end of a neck 30 and a head or headstock connected to neck 30 at the neck's distal end. A series of strings 50 comprising the new nickel cast iron of the present disclosure traverses the neck 30 from the distal end through to the proximal end and further down the body 20. Strings 50 are designed to produce musical notes of a known pitch in their natural state, that is, when they are not physically manipulated to change their lengths by a guitarist's hands as they are plucked, strummed, or otherwise played. Each of individual strings 50 will be so naturally tuned to a single pitch by providing the string with a thickness to produce that pitch. A guitar typically has 6 strings that have individual pitches that, from low to high, are E, A, D, G, B and E. The different pitches are attained for the six strings by constructing the strings thicker of the lower pitches and progressively thinner towards the higher pitches. Strings 50 will come in a set of these six musical notes but may also be obtained separately. Conventional strings are made of a carbon steel outer wrap that is anodized with an 8% flash of nickel plating, or stainless steel over a carbon steel plain core wire. These conventional strings will lose their thicknesses under the constant hard physical manipulation that is typical in heavy metal, rock music and this degradation makes conventional strings brittle so that they often break during playing. This is a particular issues for the higher treble strings. This is much less of a problem for the novel strings described herein since the particular composition of the nickel cast iron that is used to produce these strings reduces the degradation of the string thicknesses and they rarely break during playing. This solves a long felt need in the art for strings which do not fail during playing which allows concerts and recordings to continue unimpeded.

Strings 50 are secured to head 40 by a series of six tuning screws 60 to which each of the strings is individually wrapped and secured. As guitarists understand, each string 50 is placed on each individual screw 60 in the correct order so that the lowest pitch string will be closest to the guitarist's upper body in the normal position of guitar 10 during playing and each next highest string will be further down the guitarist's body. This correct order allows the guitarist to produce notes and chords as is conventional in guitar playing. By slightly tightening and loosening tuning screws 60 on a periodic basis, the individual strings are tuned to their natural pitches. At the proximal end of neck 30 a nut 70 is provided which acts to hold the strings 50 above the neck at a distance which allows the guitarist to press each string to the neck and change its length, thereby changing its pitch for varied pitch production and chord production. Toward the end of body 30 a bridge 80 is provided which suspends string 50 above the body, thereby allowing the guitarist to engage the strings for playing without being impeded by the body 30.

A fretboard 90 having individual frets 100 is fashioned on neck 30. Fretboard 90 is a thin, long strip of material, usually wood, which is laminated to the front of the neck of guitar 10. Strings 50 run over the fretboard 90, between the nut 70 and bridge 80. As mentioned above, the guitarist presses strings down to the fretboard to change the vibrating length, thereby changing the pitch. Frets 100 let the guitarist stop the string consistently in the same place, which allows the guitarist to play notes with the correct intonation. Frets 100 are typically made of a hard material such as metal. The board 90 may be unfretted, in which case it is called a fingerboard and the guitarist presses strings 50 to the board 90 without guidance from the frets. Frets 100 do not dampen string vibrations as much as fingers alone on an unfretted fingerboard.

One or more pickups 110 is secured to body 30 underneath the elevated strings and electromagnetically interacts with strings 50 and the other electronic components of a system (controlled by knobs 120) that is provided for amplifying the sound created by guitar 10 with the new nickel cast iron strings 50. Many different types of pickups exist in the art today, and the sound emitted from all of these pickups may be improved with the use of the new nickel cast iron strings 50 described herein. The inventors have found that a very great improvement is achieved through the use of the new nickel cast iron strings 50 in the output of the P90 pickups. The new strings having a nickel cast iron metallurgical alloy provides sonic clarification to remedy the problems in tone and noise production of a P90 pickup described above. The result is that the treble strings will have more authority and thickness of tone, while the bass string responses are now very clear and distinct, which allows the true character of the P90 pickup's design produced superior tone, clarity and richness through the guitar/amplifier combination while greatly elimination the noise hum associated with P90 pickups. The guitar's tone controls now also will work more musically, and the guitar amplifier's tonal circuitry is made much more friendly towards the P90 pickup by strings 50, giving the player the ability to add a lot more bass response. This was not achievable with prior strings before the novel nickel cast iron strings of the present disclosure were developed by the inventors.

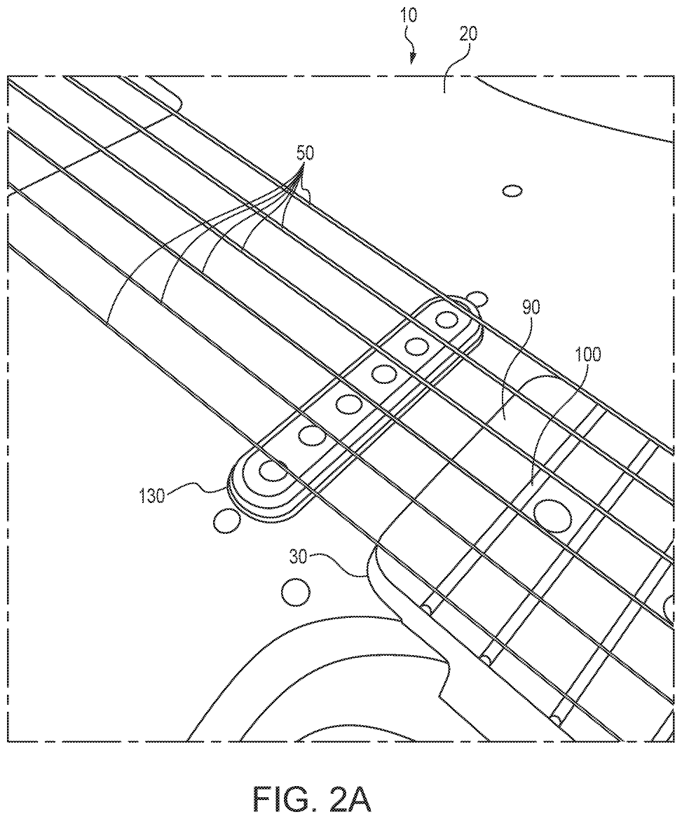

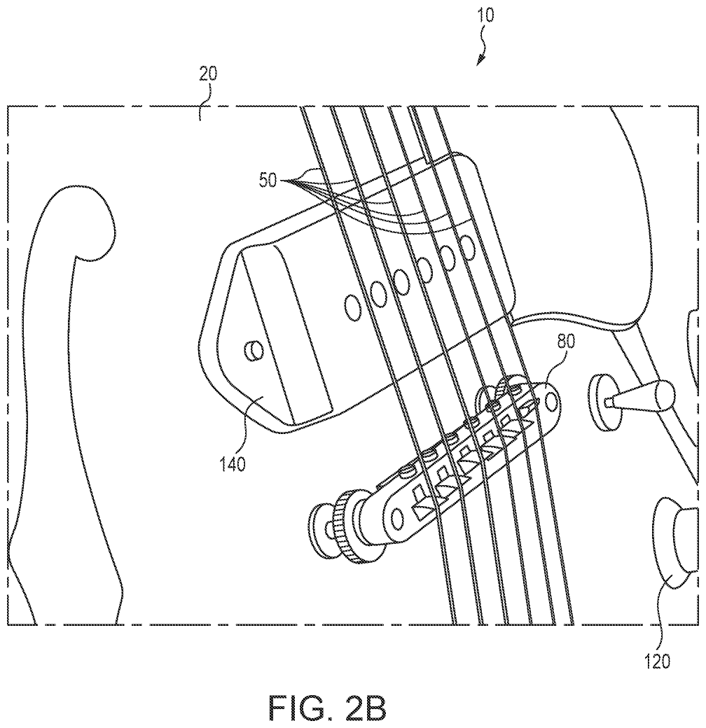

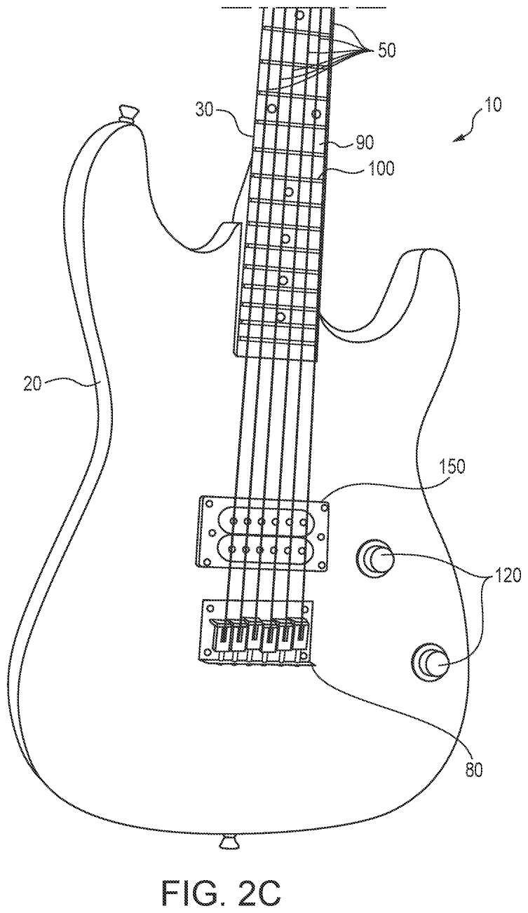

FIGS. 2A, 2B and 2C show guitars 10 having, respectively, a single coil pickup 15, a P90 pickup 14 and a humbucker pickup 150 mounted on the guitar bodies 20 in electrical communication with the novel strings 50. The single coil pickup 130 and P90 pickup 140 are variations on the single coil design but produce very different results for the amplified music being played on guitars using them. The humbucker pickup 150 is a two-coil pickup which is a very different design than the single coil pickup 134 and P90 140, and its sound production is also very different and distinguishable from the single coil designs.

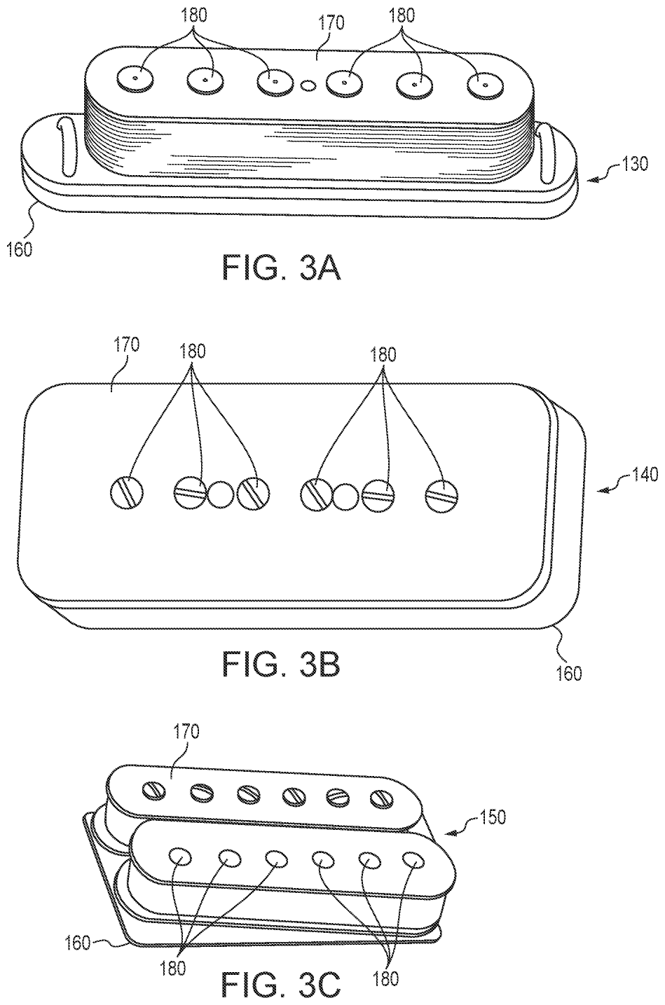

FIGS. 3A, 3B and 3C show, respectively, the single coil pickup 13, the P90 pickup 140 and the humbucker pickup 150 unmounted from a guitar body. Each of these pickups are interchangeable on guitar bodies and conventionally a guitarist can physically replace pickups on guitars depending on the types of sound the guitarist wishes to produce for a particular music style that is intended to be achieved. The pickups 130, 140, 150 have mounting plates 160 allowing the guitarist to perform pickup replacement as necessary. The pickups 150. 140, 150 have top covers 170 which cover the electronic interiors of the pickups to protect the interiors from environmental degradation and to protect the guitarist from interacting with the pickup interior electronics during playing. The pickups 130, 140, 150 have six individual pole pieces 180 positioned at longitudinally spaced intervals along a magnet inside the pickups (not shown in FIGS. 3A, 3B, 3C). Pole pieces 180 are usually made of upright cylindrical soft iron cores and are held in place by the magnetism of the magnet. The vibrations of the strings 50 as they are being handled by the guitarist causes the strings to move over the ends of the pole pieces which creates a variation in the magnetic field through the coils. Given that people pieces 180 have a north and south pole, variations in the strength of the magnetic field create electrical currents in the coil which carry the characteristic of the music played by the guitarist on strings 50 corresponding to the notes of the strings' vibrations. These electrical currents are ultimately received by an amplifier which reproduces the music which the listening public has enjoyed over the last nearly 100 years.

Single coil pickups are characterized by having a sound that is clearer and with more high frequencies. A humbucker, having two coils wired in opposite directions to each other are known to produce thicker sounds with more volume than single coil pickups. Moreover, single coil pickups are very noisy since they are very susceptible to outside interference of electrical signals. Single coil pickups essentially function as antennas due to their construction of wrapped coils around permanent magnets. However, due to their opposing coil designs, humbucker pickups are very quiet. A humbucker also works well with distortion and is particularly powerful for heavy metal rock and roll playing. P90 pickups sound somewhere in between a single coil and humbucker pickup, in that they have a good treble response, so they sound bright and crisp, like single coil pickups. However, P90 pickups have a more boosted mid-range compared to single coil pickups, which means that their tone is fuller and warmer, but not quite as much as a humbucker. Due to their versatile tone, P90 pickups are well suited to a range of different styles of music including rock, blues and country. However, they are not as well suited to metal rock and roll due to their weak bass frequencies and tendency to have a background humming noise if their gain is increased too much.

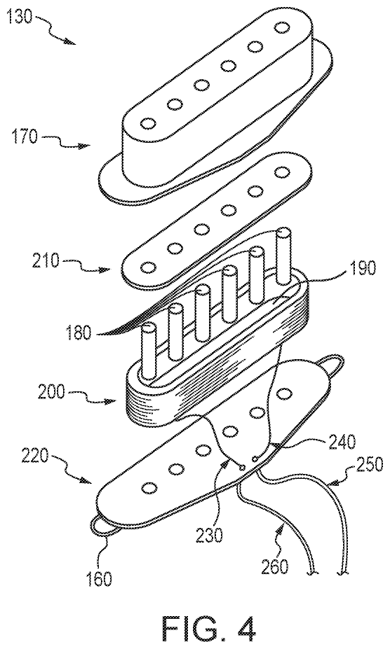

Referring now to FIG. 4, single coil pick up 130 has a cover 170, typically made of plastic or other electrically insulating material, and a mounting plate 160 of a similar material. Pole pieces 180 are disposed on top of a permanent magnet piece 190 which is wrapped in a coiled wire 200 so that strings 50 producing vibrations while played will produce the variations of the magnetic field that will ultimately be converted to amplified music. A bobbin 210 acts to house the pole pieces to secure them within the coil and allow them to freely pick up the vibration of strings 50. Bobbin 210 is usually also constructed of an electrically insulating material, and in the case of a standard single coil pickup is a rather narrow structure which provides minimal support to the coil. A bobbin base 220 may optionally be provided attached to the mounting plate 160 through which the start of the coil wire 230 and end of the coil wire 240 may be threaded. A hot wire 250 and ground wire 260 are also typically found on single coil pickup 130, as well as all other pickups.

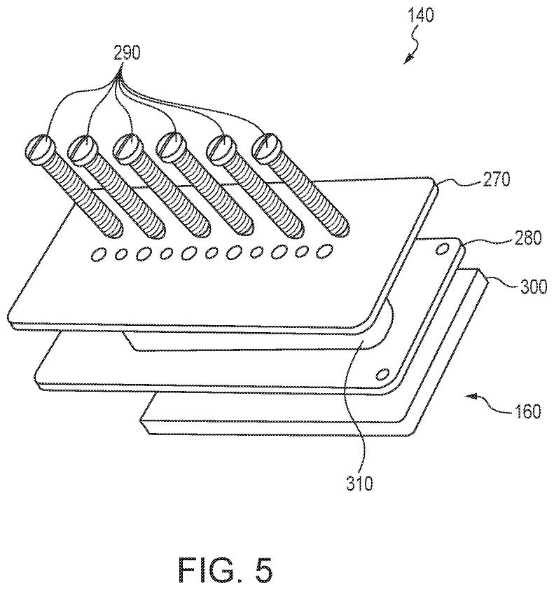

Referring now to FIG. 5, a P90 pickup 140 with cover 170 removed (not shown) in exploded view is illustrated. P90 pickup 140 is a wide aperture single coil pickup. The term “aperture” refers to how much of the length of a string 50 the coil can sense. Narrow aperture pickups tend to produce brighter, more focused pitches such as is found in the single coil pickups of FIGS. 3A and 4. The wider the aperture, the richer the sound that is produced, with more thickness and less focused pitches. One of the ways of attaining the wider aperture in a P90 pickup is as shown in Figure wherein a top bobbin 270 and a lower bobbin 280 are physically wider than bobbin 210 of the single coil pickup shown in FIG. 4. Thus, the single coil, wide aperture pickup embodied in P90 pickup shown in FIG. 5 is a more versatile pickup than the standard single coil pickup in that the sound it produces is richer, thicker and less bright. Often this is a desirable result for a guitarist playing rock and other music genres.

Another improvement that can be found in P90 pickup 140 is the provision of adjustable pole pieces 290. Such pole pieces 290 are adjustably insertable into top bobbin 270 adjustably traversing therethrough and through wire wrapped coil with core 310 to interface with permanent magnet 300. Pole pieces 290 are preferably constructed of iron or iron alloys and may be coated with a nickel plating to increase their ferromagnetic properties as desired. Pole piece adjustably with top and bottom bobbins 270, 280 provide the guitarist further possibilities to adjust the sound thickness, tone and pitch produced by the guitar according to the particular needs of the genre being played. Preferably, magnet 300 comprises alnico, which is a highly desirable material with good ferromagnetism, strong corrosion resistance and are stable across large temperature ranges. They comprise primarily aluminum, nickel and cobalt but can have small amounts of copper, iron and titanium. Alnico magnets are particularly useful in guitar pickups.

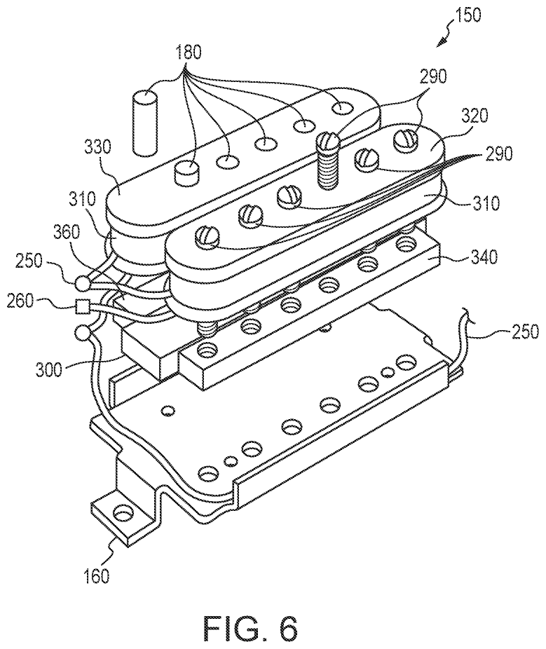

Referring now to FIG. 6, an exploded view of humbucker pickup 150 is illustrated having two wire wrapped coil structures 310 wherein the wire wrapping of one of the coils 310 is in the opposite direction of the other coil 310 so as to cancel any noise interference that may be generated in coils 310 during operation. A south bobbin 320 is disposed to receive adjustable pole screws on the south coil, while a north bobbin 330 is disposed to receive fixed pole pieces 180 on the north bobbin. Both coils are arranged so that their respective pole pieces transversely magnetically interact with alnico magnet 300 to produce electrical current to be converted to amplified music. A keeper bar 340 provides a surface to which adjustable pole pieces 290 may be screwably secured when they are engaged therethrough. Because the two coils should be electrically isolated from each other, and insulated spacer 350 is provided between the two coils to ensure this result. Spacer 350 may be, for example, made of a light, wooden material to provide isolation, but not add too much weight to the coil. Since humbucker pickup 150 is essentially two coil structures with its attendant supporting structure such as keeper bar 40 and spacer 350, it has the widest structure from north to south as can be seen and as compared to single coil pickup 130 and P90 pickup 140, thereby providing humbucker pickup 150 with the widest aperture available in standard guitar pickups. The humbucker coil therefore produces the thickest sounds available, and is particularly useful for in-depth, soulful music playing, for example jazz guitar musical pieces.

All of the above-described guitar pickups have in the past exclusively utilized the known, available strings on the market, particularly the steel core, nickel plated variety of guitar strings. All of these pickups will benefit enormously from the novel strings made of nickel cast iron and will produce richer, pure pitch tones with better gain and less noise production due to the use of these new strings. The new strings are an iron (Fe) nickel (Ni) alloy that preferably comprises between 90% Fe and 10% Ni, and more preferably between about 95% Fe and 5% Ni. The FeNi alloy is smelted according to known techniques, and do not involve maraging or the use of a process which could result in an amorphous FeNi alloy. The inventors of the new strings have determined that ideally, nickel cast alloy strings producing superior results as described herein should comprise about 98% Fe and 2% nickel (hereinafter referred to as “98/2” alloy). Regardless of the formulation, it will be appreciated by the skilled artisan that trace amounts of other metals and/or elements or compounds will occur in these new alloys for guitar strings.

Nickel cast iron alloy, sometimes called iron nickel alloy (FeNi alloy) is a known alloy of iron and nickel wherein the nickel can exist at varying weights within the alloy. It is a standard alloy in that it is not an amorphous alloy, and typically is not an alloy made from maraging. Iron itself is a highly ferromagnetic material. Nickel itself has high ferromagnetism and the inventors believe that when a small amount of Ni is added to Fe, the Ni tends to season the iron to stabilize the ferromagnetic properties, thereby producing an ideal metal alloy for the use in guitar strings. The addition of the Ni to the Fe also increases the alloy's strength and machinability properties, making this combination of metals in the proportions discovered by the inventors ideal for guitar string production. Nickel has previously not been used in standard iron or steel alloys to produce a good alloy for guitar strings but has only been used either to produce pure nickel guitar strings, or to coat steel cores to produce nickel coated, steel guitar strings. Both the pure nickel guitar string and the nickel coated guitar strings fail to provide guitar string which work well with single coil pickups as described above, or even with humbucker double coil pickups. Never having been used previously for guitar string production, 98/2 alloy has been used in other applications and is therefore commercially available on the market for purchase. One such supplier of 98/2 alloy is the Stanford Advanced Materials company of 23661 Birtcher Dr., Lake Forest, CA 92630 U.S.A. The 98/2 alloy comes in rolls, sheets and bars, for example.

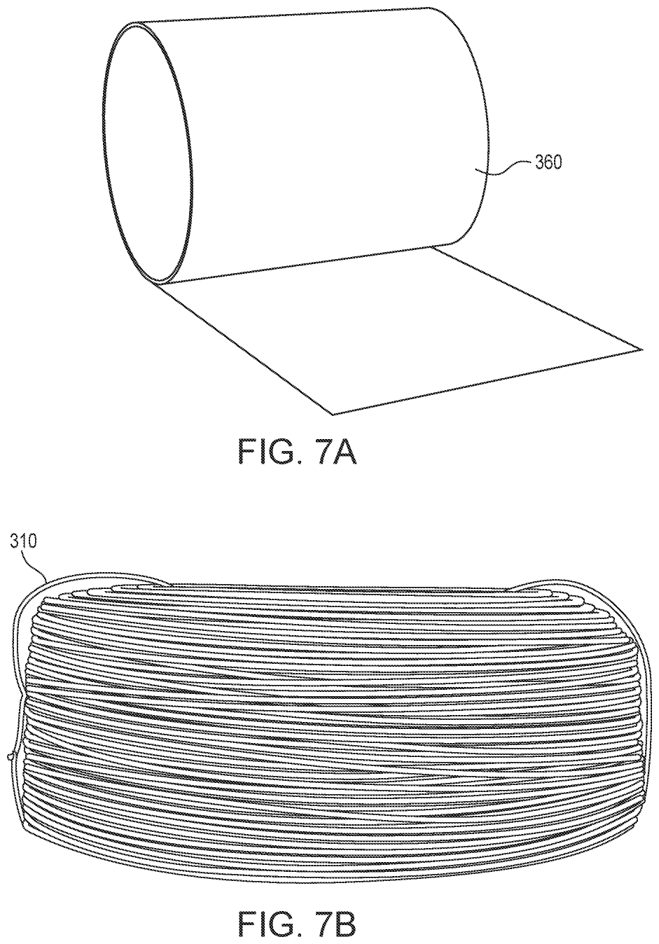

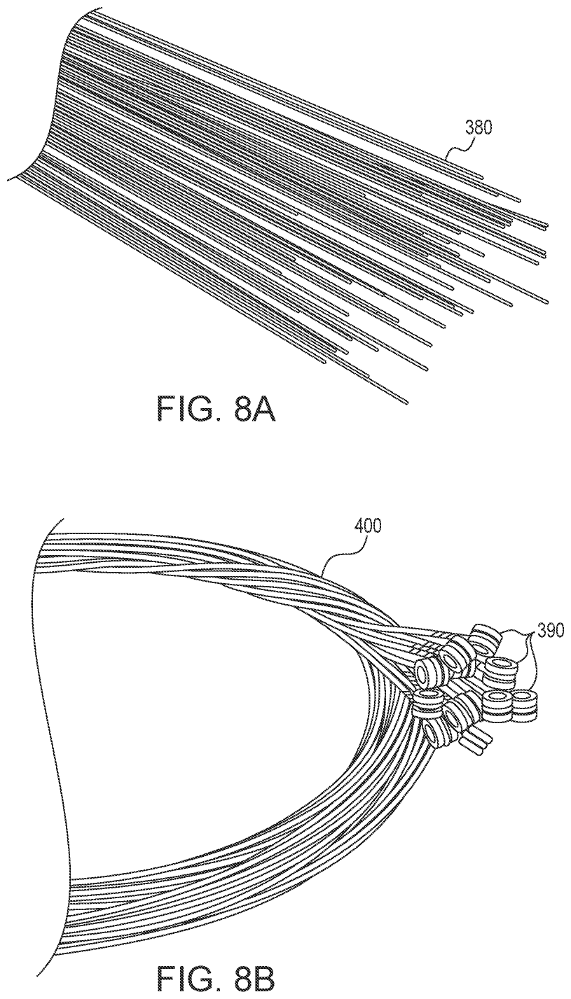

FIGS. 7A, 7B, 8A and 8B illustrate an exemplary process for producing the novel guitar strings of the present disclosure out of the preferred 98/2 alloy. Of course, it will be appreciated that other forms of the nickel cast iron can also be used to produce strings 50 as desired. The 98/2 alloy is commercially obtained in a roll 360, for example, but sheets, rods or strips could also be purchased to fabricate guitar strings 50. Roll 360 is laid out, and a cutting and forming technique is applied to roll 360 to produce a roll of elongated FeNi wire 370 having widths suitable for the individual six pitches that are necessary for the individual guitar string.

After the initial wire forming technique is completed, the wires of appropriate widths are cut the correct lengths to form wires 380 which will be used to finish the guitar sting fabrication process. Ferrules 390 are then twisted on the ends of wires 380 so that the wires can be placed in a string forming machine so that individual guitar strings of correct lengths are produced/ Ferrules 390 are also commercially available and come in a number of different varieties and materials. A preferred ferrule for this process is available from the Mojotone company of 137 Worth Beverage Drive, Burgaw, NC 28425. The wound guitar strings of appropriate lengths and widths are bundled 400 and can be sold in sets of six or individually for use.

There have thus been described certain preferred embodiments of IRON NICKEL GUITAR STRINGS AND METHODS OF MAKING THEREOF. While preferred embodiments have been described and disclosed, it will be appreciated by those with skill in the art that modifications are within the true spirit and scope of the described principles.

What is claimed is:

1. A guitar string comprising iron (Fe) and nickel (Ni) which have been smelted together to form an alloy, the alloy having between about 90% Fe and 10% Ni.

2. The guitar string recited in claim 1 wherein the alloy comprises between about 95% Fe and 5% Ni.

3. The guitar string recited in claim 2 wherein the alloy comprises between about 98% Fe and 2% Ni.

4. A guitar comprising:
a pickup;
six guitar strings comprising iron (Fe) and nickel (Ni) which have been smelted together to form an alloy, the alloy having between about 90% Fe and 10% Ni.

5. The guitar recited in claim 4 wherein the alloy comprises between about 95% Fe and 5% Ni.

6. The guitar recited in claim 5 wherein the alloy comprises between about 98% Fe and 2% Ni.

7. The guitar recited in claim 6, wherein the pickup is single coil pickup.

8. The guitar recited in 6, wherein the pickup is a wide aperture single coil pickup.

9. The guitar recited in claim 8, wherein the wide aperture single coil pickup is a P90 pickup.

10. The guitar recited in claim 6 wherein the pickup is a humbucker pickup.
